(19) United States
(12) Patent Application Publication
(10) Pub. No.: US 2026/0209447 A1
(43) Pub. Date: Jul. 23, 2026

(54) METHOD FOR PREPARING A THERMOSETTING BINDER COMPOSITION BASED ON WATER-SOLUBLE OR WATER-DISPERSIBLE LIGNIN ESTER, FOR BINDING FIBRES

(71) Applicant: SAINT-GOBAIN ISOVER, COURBEVOIE (FR)

(72) Inventor: Arnaud SOISSON, AUBERVILLIERS (FR)

(21) Appl. No.: 19/140,204

(22) PCT Filed: Dec. 19, 2023
(86) PCT No.: PCT/FR2023/052058

§ 371 Date: Jun. 17, 2025

(30) Foreign Application Priority Data
Dec. 19, 2022 (FR) FR2213857

(51) Int. Cl. C08H 7/00; B27N 3/00; B27N 3/04; C08L 97/00; C08L 97/02; D04H 1/26; D04H 1/4218; D04H 1/587; D04H 1/645

(52) U.S. Cl. CPC C08H 6/00; B27N 3/002; B27N 3/04; C08L 97/005; C08L 97/02; D04H 1/26; D04H 1/4218; D04H 1/587; D04H 1/645; D10B 2505/00

(57) ABSTRACT

A method for preparing a thermosetting binder composition, includes mixing at least one lignin, at least one organic monocarboxylic or sulfonic acid, and at least one organic non-polymeric polycarboxylic acid, and heating the mixture at a temperature of between 90° C. and 170° C., for a duration of between 5 seconds and 5 minutes so as to form at least one water-soluble or water-dispersible lignin ester.

The present invention relates to a method for preparing a thermosetting binder composition based on a water-soluble or water-dispersible lignin ester obtained by reaction between a lignin, in the presence of an organic monocarboxylic or sulfonic acid, with an organic non-polymeric polycarboxylic acid, and also relates to the thermosetting binder composition obtained by such a method.

The invention also relates to the use of such a thermosetting binder composition in a method for manufacturing an insulation product. Said thermosetting binder composition, after dilution in water, forms an aqueous sizing composition, enabling both natural organic fibers and mineral fibers to be bonded together (after curing of this sizing composition on the fibers), for the manufacture of insulation products. These insulation products, obtained by said method, are usually used to produce low-density wood fiber boards (density of less than 250 kg/m³) and mineral fiber boards having a density of less than 120 kg/m³.

It has been known for several years to use aqueous compositions based on sugars as thermosetting binders for bonding mineral fibers, in particular mineral wools.

In particular, it has been proposed to form thermoset polyesters by reacting reducing sugars and/or non-reducing sugars and/or hydrogenated sugars, bearing hydroxyl groups, together with polycarboxylic acids in the presence of a catalyst, generally sodium hypophosphite (WO 2009/080938, WO 2010/029266, WO 2013/014399, WO 2013/021112). However, these binders based on sugar(s) require a very high temperature, generally between 180° C. and 210° C., to form over a period of generally less than 30 min; this is why they have proved unsuitable for bonding natural organic fibers, as said organic fibers are then degraded (or even burnt) at such temperatures.

The sizing compositions described in the aforementioned documents are dilute, low-viscosity aqueous solutions and monomer reagents having low molar masses of less than 500 g·mol⁻¹. They are generally sprayed on mineral fibers that are still hot, immediately after the formation thereof. Immediately after application of the sizing composition to the fibers, the evaporation of the aqueous phase begins. When the fibers are collected and assembled as a mat on the collecting belt, they are tacky and the film of sizing composition that surrounds the mineral fibers still contains water.

It is only when the sized mineral fiber mat enters the oven, typically temperature-controlled at temperatures of greater than 180° C., or even greater than 200° C., that the evaporation of the water is completed and the esterification reaction between the reagents begins.

Heating the sized fiber mat at high temperatures for a few minutes thus leads to the curing (or crosslinking) of the reactive system and to the formation of a water-insoluble organic binder, and consequently to the desired insulation product. This final step therefore requires high temperatures, thus needing large amounts of energy to manufacture the desired insulation products.

Sizing compositions based on phenolic resol-type resins are commonly used to bind both mineral fibers and natural organic fibers, in particular medium- and high-density natural organic fibers (densities of greater than 250 kg/m³). In addition to their good crosslinking ability, these resins are water-soluble and relatively inexpensive.

The commonest resols are obtained by condensation of phenol and formaldehyde, in the presence of a basic catalyst. However, ultimately, these resols contain a certain proportion of unreacted monomers, in particular formaldehyde, the presence of which is undesirable on account of its known harmful effects. For this reason, resol-based resins are generally treated with urea which reacts with the free formaldehyde, trapping it in the form of nonvolatile urea-formaldehyde condensates. Moreover, the presence of urea in the resin gives a certain economic advantage owing to its low cost, as it can be introduced in relatively large amounts without affecting the usage qualities of the resin, in particular without adversely affecting the mechanical performance of the finished product, which lowers the total cost of the resin considerably.

It has nevertheless been observed that, under the high temperature conditions to which the fibers are subjected in order to obtain crosslinking or curing of the sizing composition based on said resols, the urea-formaldehyde condensates are unstable. They decompose, giving formaldehyde and urea again, which in turn is at least partially degraded to give ammonia, which are released into the plant atmosphere and then have to undergo capturing procedures in order to reduce their environmental impact.

In addition, in order to bind natural organic fibers, and in particular to obtain insulation products having a density of less than 250 kg/m³, it is known to use binders obtained after curing or crosslinking of sizing compositions comprising polyisocyanates. Among the polyisocyanates most commonly used in the wood fiber industry, mention may be made of poly(methylene diphenyl isocyanate) (pMDI, CAS number 9016-87-9) which is a technical grade blend containing of 30-80% MDI (methylene diphenyl isocyanate) and higher molecular weight homologs of formula:

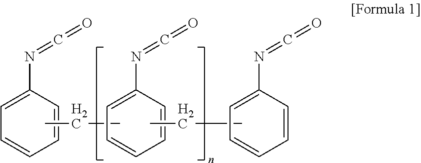

In order to ensure good wetting of the natural organic fibers by the hydrophobic pMDI, it is generally necessary to subject the fibers to drying beforehand, so as to reduce their water content to a value less than or equal to 6% by weight, in particular of between 2-6% by weight (see WO2008/144770).

Proposed more recently are emulsifiable pMDIs (EMDI), which are either mixtures of pMDI with non-ionic surfactants free of labile hydrogens capable of reacting with isocyanate functions (see for example EP0516361), or mixtures of pMDI and a low percentage of pMDI functionalized with hydrophilic chains, for example polyethoxylated chains allowing to stabilize the emulsion.

The use of pMDI in the form of aqueous emulsions allows an even distribution of the binder on natural organic fibers without preliminary drying, which constitutes a significant energy saving.

However, the use of polyisocyanate-based binders, even in the form of aqueous pMDI emulsions, constitutes a major problem in terms of harmfulness at site for manufacturing the insulation products, due to the presence of polyisocyanates. Furthermore, polyisocyanates are expensive raw materials and are highly reactive. Thus, polyisocyanate-based sizing compositions can cure before the insulation product is shaped and heated, requiring time-consuming cleaning of equipment and, above all, resulting in production stoppages.

To overcome the aforementioned disadvantages, the present invention is based on the discovery that it was possible:
using a special method, to obtain a thermosetting binder composition that is relatively harmless, inexpensive, and stable but sufficiently reactive, for use thereof (after dilution in water) in binding both mineral fibers and natural organic fibers, and thus in manufacturing insulation products having good mechanical properties,
to lower the temperature and, above all, to speed up the duration of the step for heating the fiber assembly, leading to curing of the sizing composition (obtained by diluting the binder composition in water) on the different types of fiber, to form the organic binder;
by subjecting a system of starting reagents, based on lignin(s) and polyacid(s), beforehand, to a polycondensation (or esterification) reaction, preferentially in an anhydrous and/or solvent-free medium, in other words well before said reagents are applied to the fibers, in a pre-polymerization (or pre-polycondensation) step.

The present application thus relates to a method for preparing a thermosetting binder composition comprising the following steps:
mixing at least one lignin, at least one organic monocarboxylic or sulfonic acid, and at least one organic non-polymeric polycarboxylic acid, and
heating said mixture at a temperature of between 90° C. and 170° C., preferably between 110° C. and 150° C., for a duration of between 5 seconds and 5 minutes, preferably between 15 seconds and 1 minute, so as to form at least one water-soluble or water-dispersible lignin ester.

In the present application, the terms thermosetting “binder composition” and “sizing composition” are not synonyms. The term thermosetting “binder composition” refers to concentrated aqueous solutions or dispersions, that is having a high solids or dry matter content (several tens of percent). These compositions may be stored and transported. They are rather fluid in order to be able to be pumped, but too viscous to be sprayed as such on the fibers. The term “sizing composition” refers to considerably less concentrated aqueous solutions or dispersions having a dry matter content of less than 20% by weight. They are generally obtained by diluting thermosetting binder compositions with water. They have sufficiently low viscosities to enable their application to natural organic fibers or to mineral fibers by spraying using nozzles or by impregnation. Thus, in the present application, “organic binder” means an insoluble binder obtained by curing (or crosslinking) of the aqueous sizing composition previously applied to the fibers, during the step of heating the assembly of said fibers.

It was surprisingly found by the inventors that the method according to the invention made it possible to obtain a pre-polymerized binder composition comprising at least one lignin ester which is stable and water-soluble or water-dispersible at room temperature. Indeed, said binder composition comprising at least one lignin ester can form pumpable and infinitely dilutable aqueous solutions or dispersions, which can then be used as aqueous sizing compositions to bind both mineral fibers and natural organic fibers. These aqueous solutions or dispersions can have viscosities that are entirely compatible with a conventional sizing system for different types of fiber, for example by spraying using nozzles (such as a spray ring) or by impregnation. In the present application, “water-soluble” means a lignin ester which is dissolved up to 30% by weight in water, and “water-dispersible” means a lignin ester, the particles of which are dispersed up to 30% in water, without precipitation.

In the present application, “pre-polymerized” or “pre-polymerization” means an esterification reaction between some of the aliphatic hydroxyl groups of the lignin and some of the carboxyl groups of the non-polymeric polycarboxylic acid(s), and between some of the hydroxyl groups of the lignin and some of the carboxyl groups of the lignin itself, leading to the formation of the lignin ester.

In the method for preparing a thermosetting binder composition according to the invention, the mixture comprises at least one lignin. The lignin according to the invention is a lignin extracted from what is referred to as “native” lignin, a biomolecule belonging to a family of polymeric polyphenolic macromolecules (broadly the tannin family), which is one of the main components of wood along with cellulose and hemicellulose. Native lignin is a macromolecule with a molar mass well in excess of 10,000 g·mol⁻¹, and is not soluble in water. Native lignin is found mainly in vascular plants and some algae. The main functions thereof are to provide rigidity, waterproofing and high resistance to decomposition. All vascular plants, whether woody or herbaceous, produce lignin. Quantitatively, native lignin content is 3 to 5% in leaves, 17 to 24% in herbaceous stems, 18 to 33% in woody stems (18 to 25% of hardwood in angiosperm trees, 27 to 33% of softwood in gymnosperm trees). It is less common in annual plants than in perennial plants, but is very common in trees. Native lignin is chiefly located between cells, but a significant amount thereof is also found inside those same cells. After cellulose (constituting 35 to 50% of terrestrial plant biomass) and hemicellulose (30 to 45%), lignin (15 to 25%) is the third most abundant family of compounds in plants and terrestrial ecosystems, where dead or living plant biomass dominates.

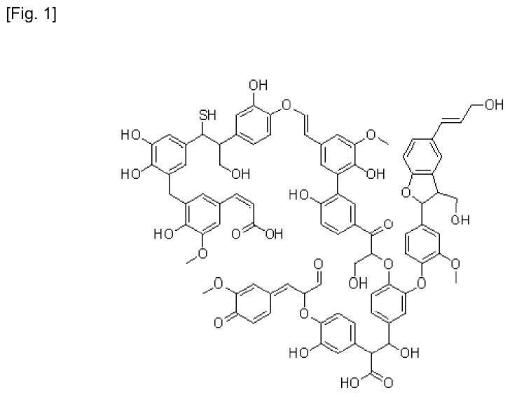

The lignin according to the invention is a macromolecule, one possible structure of which is shown in FIG. 1 [FIG. 1]. The lignin according to the invention is extracted by cleavage of the β-O-4 ether bonds of the native lignin and therefore has a lower molar mass than the native lignin from which it is derived, that is, an average molar mass of less than 10,000 g·mol⁻¹, preferably a molar mass of between 1,000 g·mol⁻¹ and 9,000 g·mol⁻¹.

The lignin according to the invention can be selected from alkaline lignins, also known as kraft lignins, lignosulfonates, organosolv lignins, sodium lignins, lignins from the process for biorefining lignocellulosic raw materials, or a mixture thereof. The four groups of commercially available lignins are alkaline or kraft lignins, lignosulfonates, organosolv lignins (extracted lignins and sodium lignins). The fifth group is the so-called biorefinery lignin, which is a little different in that it is not described by its extraction method, but rather by the origin of the method, for example, by biorefining, and can therefore be similar to or different from any of the other groups mentioned. The lignin according to the invention is preferably alkaline lignin, also known as kraft lignin.

FIG. 1 shows a possible lignin structure according to the invention, comprising both hydroxyl groups —OH and carboxyl groups —COOH. It can thus be noted that the reactive functional group present in the largest amount in a typical lignin is the hydroxyl group, which is either an aromatic hydroxyl group or an aliphatic hydroxyl group, that is a primary alcohol function or a secondary alcohol function. It is known that the hydroxyl and carboxyl groups of lignin can react with crosslinking agents such as isocyanates or epoxides, amines or aldehydes, leading to a crosslinked structure of the lignin, according to different crosslinking mechanisms. However, these cross-linking agents are of less interest due to their toxicity (isocyanates, amines, formaldehyde) and/or cost (epoxides, amines, aldehydes other than formaldehyde).

In addition, it is known to use lignin in binders; however, these generally do not offer mechanical properties that are equivalent to insulation products obtained from customary binders, due to their heterogeneous structure and their low chemical reactivity.

In the present application, the inventors discovered that non-polymeric polycarboxylic acids, which are themselves low in toxicity, could react with lignin and more specifically with the aliphatic hydroxyl functions of lignin (by esterification) to form a thermosetting binder composition based on lignin ester, in order to bind mineral fibers and natural organic fibers and to subsequently obtain insulation products having good mechanical properties.

Thus, according to the method for preparing a thermosetting binder composition according to the invention, at least one lignin is mixed with at least one organic “non-polymeric” polycarboxylic acid.

In this application, the term organic “non-polymeric” polycarboxylic acid means an organic polycarboxylic acid which is not a macromolecule consisting of the assembly of monomers having a molar mass of between 90 g·mol⁻¹ and 350 g·mol⁻¹, bonded together in a repeating manner by covalent bonds. Thus, in the present application, the thermosetting binder composition is preferably free of organic polymeric polycarboxylic acid. The organic non-polymeric polycarboxylic acid according to the invention can be selected from dicarboxylic acids, in particular oxalic acid, malonic acid, succinic acid, glutaric acid, adipic acid, pimelic acid, suberic acid, azelaic acid, sebacic acid, malic acid, tartaric acid, tartronic acid, aspartic acid, glutamic acid, fumaric acid, itaconic acid, maleic acid, traumatic acid, camphoric acid, phthalic acid, in particular containing at least one boron or chlorine atom, tetrahydrophthalic acid, in particular containing at least one chlorine atom, isophthalic acid, terephthalic acid, mesaconic acid and citraconic acid, tricarboxylic acids, in particular citric acid, tricarballylic acid, 1,2,4-butanetricarboxylic acid, aconitic acid, hemimellitic acid, trimellitic acid and trimesic acid; and tetracarboxylic acids, in particular 1,2,3,4-butanetetracarboxylic acid and pyromellitic acid. Even more preferably, the organic non-polymeric polycarboxylic acid is selected from maleic acid, succinic acid, glutaric acid, itaconic acid and citric acid.

The applicant conducted tests to determine the respective proportions of lignin and organic non-polymeric polycarboxylic acid required to form the thermosetting binder composition based on lignin ester, in order to give, after dilution of said binder composition, an organic binder that imparts the best mechanical properties to the final insulation product. These tests showed that, in the method for preparing the thermosetting binder composition according to the invention, the lignin(s) can represent at least 50% of the total weight of the organic non-polymeric polycarboxylic acid(s) and lignin(s). Even more preferentially, the lignin(s) represent(s) from 50% to 80% of the total weight of the organic non-polymeric polycarboxylic acid(s) and lignin(s). Consequently, the organic non-polymeric polycarboxylic acid(s) advantageously represent(s) from 20% to 50% by weight of the total weight of the organic non-polymeric polycarboxylic acid(s) and lignin(s).

The mixture according to the method of the invention also comprises at least one organic monocarboxylic acid or at least one organic sulfonic acid. Preferably, the organic monocarboxylic or sulfonic acid(s) represent(s) at most 50% of the weight of the mixture consisting of the lignin(s), the organic non-polymeric polycarboxylic acid(s) and the organic monocarboxylic or sulfonic acid(s). More preferentially, the organic monocarboxylic or sulfonic acid(s) represent(s) from 5% to 50% of the weight of the mixture consisting of the lignin(s), the organic non-polymeric polycarboxylic acid(s) and the organic monocarboxylic or sulfonic acid(s).

The role of the organic monocarboxylic or sulfonic acid in the reaction mixture according to the invention is to adjust the pH of the lignin so that it is between 6.5 and 10.5, preferably between 8 and 9, between 10 and 20% in aqueous solution.

The organic monocarboxylic acid can be selected from the group consisting of formic acid, acetic acid, propionic acid, butyric acid, isobutyric acid, pentanoic acid, the lignin(s), the organic isovalerianic acid(s), hexanoic acid, heptanoic acid, octanoic acid, nonanoic acid, decanoic acid, undecanoic acid, dodecanoic acid, tridecanoic acid, tetradecanoic acid, pentadecanoic acid, palmitic acid, heptadecanoic acid, stearic acid, nonadecanoic acid, arachidic acid, behenic acid, lignoceric acid, cerotic acid, myristoleic acid, palmitoleic acid, sapienic acid, oleic acid, elaidic acid, trans-vaccenic acid, linoleic acid, linolelaidic acid acid, α-linolenic acid, γ-linolenic acid, dihomo-γ-linolenic acid, arachidonic acid, eicosapentaenoic acid, clupanodonic acid, docosahexaenoic acid, crepenynic acid, tuberculostearic acid, phytanic acid, lactobacillic acid, malvalic acid, chaulmoogric acid, gorlic acid, 11-cyclohexylundecanoic acid, 13-phenyltridecanoic acid, furanic fatty acids, pentacycloanammoxic acid and benzoic acid. The particularly preferred organic monocarboxylic acid is acetic acid.

The organic sulfonic acid preferably corresponds to the general formula: R—S(═O)₂—OH, wherein R represents an alkyl or aryl group and S(═O)₂—OH is sulfonyl hydroxide. In addition, the organic sulfonic acid is advantageously selected from the group consisting of methylsulfonic acid, ethylsulfonic acid, propylsulfonic acid, butylsulfonic acid, methanedisulfonic acid, ethanedisulfonic acid, propanedisulfonic acid, butanedisulfonic acid, benzenesulfonic acid and para-toluenesulfonic acid. In particular, the sulfonic acid is para-toluenesulfonic acid.

In a preferred embodiment, at least one lignin is first mixed with at least one organic monocarboxylic or sulfonic acid in the presence of a water content which may be less than 5% by weight, preferentially less than 1% by weight, so that the pH of the lignin in solution is between 6.5 and 10.5, preferably between 8 and 9. Adjusting the pH of lignin makes it possible to maximize its reactivity with the organic non-polymeric polycarboxylic acid without unduly affecting its solubility in water. Then, at least one organic non-polymeric polycarboxylic acid can be added to said premix, preferably in the absence of solvent.

Thus, the reaction mixture for the polycondensation between at least one lignin, in the presence of at least one monocarboxylic or sulfonic acid, and at least one organic non-polymeric polycarboxylic acid, can contain less than 5% water by weight, preferentially less than 1% water by weight and, more advantageously, the mixture is anhydrous. In some cases, water makes it possible to homogenize the reagents in the reaction mixture. This water required for homogenization evaporates under the effect of the step of heating the reaction mixture.

Furthermore, advantageously, the mixture of at least one lignin, at least one organic monocarboxylic or sulfonic acid, and at least one organic non-polymeric polycarboxylic acid contains less than 5% by weight of aqueous and/or organic solvents, preferentially less than 1% by weight of aqueous and/or organic solvents. Even more preferentially, said mixture is solvent-free.

The mixture can be free of polyols, and more particularly of hydrogenated sugars.

The mixture can also comprise a catalyst, the role of which is in particular to lower the temperature of the pre-polymerization (crosslinking) between the lignin and the organic non-polymeric polycarboxylic acid. The catalyst can be a compound containing phosphorus, for example an alkali metal hypophosphite salt, an alkali metal phosphite, an alkali metal polyphosphate, an alkali metal hydrogen phosphate, a phosphoric acid or an alkylphosphonic acid. Preferably, the catalyst is sodium hypophosphite, sodium phosphite and mixtures of these compounds.

The amount of catalyst introduced into the mixture can represent up to 5% of the weight of the lignin and organic non-polymeric polycarboxylic acid, preferably up to 3%, and advantageously is at least equal to 2%.

In another preferred embodiment, the mixture is catalyst-free, as the step of heating the mixture of at least one lignin, at least one organic monocarboxylic or sulfonic acid, and at least one organic non-polymeric polycarboxylic acid makes it possible to avoid the use of such a catalyst, which is often toxic and can promote depolymerization and hence aging of the final insulation product.

According to the method of the invention, the reaction mixture is heated at a temperature of between 90° C. and 170° C., preferably between 110° C. and 150° C., for a duration of between 5 seconds and 5 minutes, preferably between 15 seconds and 1 minute, so as to form at least one water-soluble or water-dispersible lignin ester.

The mixture can be heated using a temperature-regulated enclosure or in a reactor equipped with a mechanical stirrer.

The degree of progress of the polymerization reaction between at least one lignin and at least one organic non-polymeric polycarboxylic acid during heating of the reaction mixture can be monitored by measuring the enthalpy of reaction using differential scanning calorimetry (DSC). The degree of progress of the reaction is determined by the difference between the initial state (maximum enthalpy) and the final state (enthalpy=0). The measurement apparatus used by the applicant is the Discovery DSC model from TA Instruments.

Indeed, when the desired degree of polymerization is reached, heating is stopped and the thermosetting binder composition based on a water-soluble or water-dispersible lignin ester is obtained using the method as described.

The present application also relates to a thermosetting binder composition that can be obtained by the method as described above, said binder composition containing at least one water-soluble or water-dispersible lignin ester, at least one residual lignin, at least one free residual organic non-polymeric polycarboxylic acid, and at least one free residual organic monocarboxylic or sulfonic acid.

The thermosetting binder composition advantageously contains at least one lignin ester having a molar mass of between 1,000 g·mol⁻¹ and 20,000 g·mol⁻¹, preferably between 1,000 g·mol⁻¹ and 10,000 g·mol⁻¹; the lignin ester being obtained by pre-polymerization, that is by esterification reaction between aliphatic hydroxyl groups of the lignin and carboxyl groups of the non-polymeric polycarboxylic acid(s), and between hydroxyl groups of the lignin and carboxyl groups of the lignin itself.

Thus, the content of free residual organic non-polymeric polycarboxylic acid can be at most 45% by weight, relative to the total dry weight of the thermosetting binder composition, and the content of free residual organic monocarboxylic acid or the content of free residual organic sulfonic acid is at most 45% by weight, relative to the total dry weight of the thermosetting binder composition. “Free residual” means the content of organic non-polymeric polycarboxylic acid that has not reacted with the lignin during pre-polymerization, or the content of organic monocarboxylic or sulfonic acid that has not exchanged H⁺ ions with the lignin. The thermosetting binder composition obtained by the method contains, as mentioned above, at least one residual lignin, meaning an amount of unreacted lignin.

In particular, the thermosetting binder composition has a pH of between 2 and 6, preferably of between 2.5 and 5, at 10% in aqueous solution. The water content of the thermosetting binder composition can be less than 3% by weight, preferably less than 0.5% by weight.

The inventors found that, due to its acidic pH and low water concentration, the thermosetting binder composition that can be obtained by the method had good storage stability at room temperature and could therefore be transported, as previously explained.

Furthermore, the inventors noted that the use of the lignin ester contained in a thermosetting binder composition as prepared according to the method of the invention:
instead of reagents “based on sugars and polyacids” in a sizing composition applied directly to mineral fibers, makes it possible to lower the temperature of the step of heating the assembly of said fibers and also to accelerate the duration of the step of heating the assembly of fibers,
instead of polyisocyanates applied directly to natural organic fibers, makes it possible to prevent the sizing composition from curing on said before they pass into the appropriate heating device,
instead of the reagents: “at least one lignin, at least one organic monocarboxylic or sulfonic acid, and at least one organic non-polymeric polycarboxylic acid”, in a sizing composition applied directly to any type of fiber (in other words, without a pre-polymerization step), makes it possible, for a given oven temperature, to shorten the duration required for satisfactory curing of the binder on the fibers the step of heating the assembly of said fibers, making it possible to save energy on the heating of the oven or heating press and to speed up the production line for the insulation products, while still obtaining insulation products having good mechanical properties.

Thirdly, the present application relates to a method for manufacturing an insulation product comprising mineral fibers or natural organic fibers bonded by an organic binder, using a thermosetting binder composition according to the invention.

This method comprises the following steps:
(a) preparing a sizing composition by diluting a thermosetting binder composition as described above with water until a dry matter content of between 1% and 20% by weight, preferably between 2 and 10% by weight, is reached,
(b) applying the sizing composition to said mineral fibers or said natural organic fibers,
(c) forming an assembly of said sized mineral fibers or said sized natural organic fibers, and
(d) heating the assembly of said mineral fibers or said natural organic fibers until said sizing composition has cured to form the organic binder.

To obtain good-quality insulation products, it is necessary for the sizing composition to have good sprayability and be able to be deposited as a thin film on the surface of the fibers in order to bind them effectively, or the sizing composition must impregnate the fiber, but not too much (with a contact angle of slightly less than 90°). The sprayability of the sizing composition is directly related to the possibility of diluting the concentrated thermosetting binder composition with a large amount of water. The diluted sizing composition must be a solution that is stable over time and that does not give rise to demixing phenomena.

The ability to be diluted is characterized by the “dilutability”, which is defined as the volume of deionized water that can, at a given temperature, be added to a unit volume of the binder composition before permanent cloudiness appears. It is generally considered that a binder composition is suitable for use as sizing when its dilutability is equal to or greater than 1000%, at 20° C.

Thus, the aqueous sizing composition, obtained after dilution of the thermosetting binder composition based on lignin ester during step (a) of the abovementioned method, can have a dry matter content of between 1% and 20% by weight, preferably between 2% and 10% by weight.

The step of preparing the sizing composition advantageously comprises the addition of one or more known additives commonly used in the technical field of mineral fibers or natural organic fibers. As regards the mineral fibers, these additives are selected, for example, from dust-prevention additives, silicones and coupling agents.

The aqueous sizing composition can be applied to the mineral fibers or natural organic fibers in an amount of between 1% and 20% by weight, preferably between 2% and 15% by weight, said amount being expressed as dry matter relative to the weight of the mineral fibers or natural organic fibers, in order to impart the desired mechanical properties to the insulation product.

In a preferred embodiment of the method of the invention, step (b) of applying the sizing composition to the mineral fibers or natural organic fibers can be carried out by spraying, in particular by means of spray nozzles, or by roller coating or by impregnation.

The mineral fibers according to the invention are preferentially mineral wools and even more preferentially glass, rock or slag wools, or mixtures thereof. In particular, when the mineral fibers are mineral wools, they may contain a composition corresponding to the following formulation, in percent by weight:
SiO₂: between 30 and 50%, preferably between 35 and 45%,
Na₂O: between 0 and 10%, preferably between 0.4 and 7%,
CaO: between 10 and 35%, preferably between 12 and 25%,
MgO: between 1 and 15%, preferably between 5 and 13%,
CaO+MgO: between 11 and 40% cumulatively,
Al₂O₃: between 10 and 27%,
K₂O: between 0 and 2%, preferably between 0 and 1%,
Iron oxide: between 0.5 and 15%, preferably between 3 and 12%,
other oxide(s): between 0 and 5% cumulatively, preferably less than 3%,
the remainder consisting of unavoidable impurities.

Mineral fibers can be glass fibers or rock fibers, in particular basalt (or wollastonite). And more particularly, the mineral fibers according to the invention are fibers of aluminosilicate glass, notably aluminosilicate glass fibers comprising aluminum oxide, Al₂O₃, in a fraction by weight of between 14% and 28%. In another embodiment, the mineral fibers may be glass fibers containing a composition corresponding to the following formulation, in percent by weight:
SiO₂: between 50 and 75%, preferably between 60 and 70%,
Na₂O: between 10 and 25%, preferably between 10 and 20%,
CaO: between 5 and 15%, preferably between 5 and 10%,
MgO: between 1 and 10%, preferably between 2 and 5%,
CaO and MgO together preferably representing between 5 and 20%,
B₂O₃: between 0 and 10%, preferably between 2 and 8%,
Al₂O₃: between 0 and 8%, preferably between 1 and 6%,
K₂O: between 0 and 5%, preferably between 0.5 and 2%,
Na₂O and K₂O together preferably representing between 12 and 20%,
Iron oxide: between 0 and 3%, preferably less than 2%, more preferably less than 1%,
other oxide(s): between 0 and 5% by weight cumulatively, preferably less than 3% cumulatively,
the remainder consisting of unavoidable impurities.

The diameter of the mineral fibers is advantageously between 0.1 and 25 μm.

The diameter of the natural organic fibers is advantageously between 5 and 100 μm, preferably between 10 and 50 μm, and the length of these fibers is in particular between 0.1 and 900 mm, and more particularly between 10 and 120 mm. According to the invention, the natural organic fibers are advantageously fibers which are not thermoplastic, and which are naturally present in the biomass and may have undergone mechanical and/or chemical treatments. Said fibers originate from plant sources and are advantageously selected from cotton and lignocellulosic fibers. “Lignocellulosic fibers” means fibers of plant origin based on lignocellulosic material, that it to say comprising cellulose, hemicellulose and lignin. Lignocellulosic fibers include wood fibers, and fibers from other plants for example hemp, flax, sisal, cotton, jute, coconut, raffia, abaca fibers, or even cereal straw or rice straw.

The term “lignocellulosic fibers” as used in the present application does not include lignocellulosic materials having undergone thermomechanical or chemical treatments for the manufacture of paper pulp.

The lignocellulosic fibers used in the present invention therefore have simply undergone a mechanical comminution treatment intended to reduce and/or control the dimension of the fibers.

Lignocellulosic fibers are preferably softwood, particularly pine, fibers obtained by mechanical defibration. Their diameter is advantageously between 10 and 70 μm, preferably between 30 and 50 μm, and their length ranges from 0.1 to 100 mm, preferably from 0.5 to 50 mm, in particular from 1 to 20 mm.

The application of the sizing composition (b) preferably precedes step (c) of forming an assembly of mineral fibers or natural organic fibers, during which the sized fibers are brought together, before being heated consecutively or extemporaneously in order to cure the sizing composition, thereby forming the organic binder that bonds the fibers.

Thus, step (c) of forming an assembly of mineral fibers or natural organic fibers, which can also be referred to as the step of shaping the assembled fibers, can be carried out by molding and/or compression. The mold used for molding the products must be made of a material capable of withstanding the temperature of the heating step. It must also have a structure that allows the hot air from the curing oven to easily penetrate the molded product. The mold can for example consist of a box-shaped metal screen. The metal-screen box is preferably filled with a volume of loose fibers that is greater than its capacity and is then closed by a metal-screen cover. The fibers are thus more or less compressed depending on the excess filling volume. This excess filling volume of the box by the fibers is for example comprised between 10% and 150%, preferably between 15 and 100% and in particular between 20 and 80%.

When the method of the present invention is a continuous method, step (c) of forming an assembly of fibers can be carried out for example by compression, by means of a roller located at the entrance to the curing oven on a conveyor.

In addition, the fibers can be assembled:
into flexible fiber mats that can be rolled up, compressed or folded,
into blocks or panels of fibers which are denser and more rigid than the mats which can be rolled up,
into molded products based on fibers, for example linings of conduits or pipes,
into woven or nonwoven textiles, such as nonwoven mats of glass or organic fibers.

In a particular embodiment of the method according to the invention, the fibers are natural organic fibers impregnated with an aqueous sizing composition, and said method further comprises, between step (b) and step (c), a step of drying the fibers, the purpose of which is to evaporate enough water to make the sized or non-sized fibers substantially non-tacky. In another embodiment, the drying step can be performed before step (b). This drying step can be carried out by heating, for example in a temperature-controlled ventilated oven or else by conveying the fibers using hot dry air. It is important to ensure that the drying does not heat the natural organic fibers to an excessively high temperature that results in the softening of the dried sizing composition, or even in the onset of crosslinking of the components of the sizing composition. A drying temperature close to the boiling point of water is generally sufficient. The fibers impregnated with aqueous sizing composition are thus preferably dried by heating to a temperature of between 70° C. and 160° C. for a duration of between 1 second and 10 seconds. The natural organic fibers obtained after the drying step are surrounded by a sheath of dried sizing composition.

Step (d) of heating the assembly of mineral fibers or natural organic fibers according to the method of the invention is preferably carried out at a temperature of between 90° C. and 170° C. for a duration of between 1 minute and 10 minutes, preferably in a temperature-regulated enclosure or a steam press. A temperature-regulated enclosure may be a forced air oven wherein temperature-controlled hot gases are introduced into one or more compartments, or a heating mold with fluid circulation or resistive heater.

Consequently, the inventors have shown that pre-heating at least one lignin with at least one organic non-polymeric polycarboxylic acid in the presence of at least one organic monocarboxylic or sulfonic acid, preferentially in anhydrous and/or solvent-free medium, at a temperature of between 90° C. and 170° C., for a duration of between 5 seconds and 5 minutes, makes it possible to shorten the binder curing time in step (d) of the method for manufacturing an insulation product, which represents an energy saving. In addition, it was observed that the insulation products obtained from the two methods described above had good mechanical properties.

Thus, finally, the invention relates to an insulation product that can be obtained by the method for manufacturing an insulation product comprising mineral fibers or natural organic fibers bonded by an organic binder as described above. Said insulation product thus obtained therefore comprises mineral fibers or natural organic fibers, bonded by means of a binder obtained by curing or crosslinking a sizing composition obtained by diluting a thermosetting binder composition based on a water-soluble or water-dispersible lignin ester, which itself was obtained from at least one lignin, at least one monocarboxylic or sulfonic acid, and at least one organic non-polymeric polycarboxylic acid.

The insulation product obtained has good mechanical properties.

The insulation product obtained from natural organic fibers can have a thickness of between 10 and 300 mm, preferably between 35 and 240 mm, measured according to standard EN 823:2013, and a density of between 30 and 250 kg/m³, preferably between 100 and 250 kg/m³. The insulation product obtained can be used to make panels for the external insulation of buildings.

The insulation products obtained from mineral fibers are preferably mineral fiber boards, in particular wool or rock mineral fiber boards, which can have a thickness of between 10 and 300 mm, preferably between 30 and 210 mm, measured according to standard EN 823:2013, and a density of between 10 and 120 kg/m³, preferably between 15 and 90 kg/m³.

### EXAMPLES

### Example 1

### Preparation of a Thermosetting Binder Composition No. 1 According to the Invention

35% by weight of acetic acid is added to 45% by weight of kraft lignin A. Then, after homogenization of this premix, 20% by weight of succinic acid, relative to the total weight of lignin and succinic acid, is added. The mixture contains 3% by weight of water. The mixture is stirred and placed in an oven temperature-controlled to 150° C. for 30 seconds, so as to provide the thermosetting binder composition no. 1 containing the pre-polymerized lignin ester A. Said binder composition is highly concentrated, since the mixture is anhydrous and comprises 20% by weight of free residual acetic acid and less than 10% by weight of free residual succinic acid, relative to the total dry weight of the thermosetting binder composition.

In the event that a 10% by weight aqueous solution of the binder composition obtained is prepared in order to measure the pH, said pH is equal to 3.6.

### Preparation of the Aqueous Sizing Composition No. 1 According to the Invention

The pre-cured mixture containing the pre-polymerized lignin ester A is ground and diluted with water until a dilute solution having a dry matter content of 10% by weight is obtained.

### Preparation of a Comparative Aqueous Sizing Composition No. 2

By way of comparison, a non-pre-polymerized aqueous sizing composition no. 2, that is to say which has not undergone pre-curing, is prepared by simply mixing: acetic acid/kraft lignin A/succinic acid in a 35/45/20 ratio, and water is added until a dilute solution having the same dry matter content of 10% by weight as the sizing composition no. 2 is obtained.

### Preparation of an Aqueous Sizing Composition No. 3 According to the Prior Art

A sizing composition no. 3 is prepared by emulsifying water-emulsifiable poly(methylenediphenyl isocyanate) (pMDI). The dry matter content of the composition is equal to 60% by weight.

### Preparation of an Aqueous Sizing Composition No. 4 According to the Prior Art

An aqueous sizing composition no. 3 is prepared by simply mixing a phenolic resin (formaldehyde+phenol)/urea in an 80/20 ratio, and water is added until a dilute solution having a dry matter content equal to 60% by weight is obtained.

Each sizing composition described above, 1, 2, 3 and 4, is then used to impregnate wood fibers. The amount of aqueous sizing compositions 1, 2, 3 and 4 deposited on the wood fibers is equal to 7% by weight, expressed as dry matter relative to the weight of the wood fibers.

The impregnated wood fibers are then uniformly deposited in a stainless steel mold comprising a plurality of open cavities measuring 60 mm×10 mm×10 mm. Stainless steel bars measuring 60 mm×10 mm×8 mm are placed on the wood fibers, and the assembly is heated for a determined duration in a press temperature-controlled to a given temperature and under 10 bar of pressure.

The molds are then allowed to cool to room temperature before removing the lignocellulosic fiber specimens formed (60 mm×10 mm×2 mm).

The wood fiber specimens thus obtained have a density of around 180 kg/m³.

The flexural storage modulus (three-point bending) is then determined for each specimen by dynamic mechanical thermal analysis (DMTA) using a “TA Instruments RSA-G2 Analyzer” device. The samples are first dried for several hours in a desiccator under dynamic vacuum (20 mbar).

The operating parameters of the measuring device are as follows:
Temperature: 25° C.
Poisson's ratio: 0.45
Duration of the oscillating mechanical stress: 120 seconds
Oscillation frequency: 1.0 Hz,
Deformation: 0.1%
Sampling speed: 10 points/second.

Table 1 below shows:
the temperature and duration required, during the step of heating the wood fibers until each of the sizing compositions cures, to form the organic binder and hence the insulation product, and
the storage modulus of wood fiber specimens obtained after each of the sizing compositions is cured. Each storage modulus value is the calculated average of two to four individual measurement values.

### Results

TABLE 1

| | Binder composition | | | Conversion |
|---|---|---|---|---|
| | on wood fibres | | Duration | module |
| Sample | comprising | T°C. | (min) | (MPa) |
| 1 | pre-polymerized | 150 | 4 | 99 |
| (inv.) | lignin ester A | | | |
| 2 | lignin A + acetic | 150 | 10 | 100 |
| (comp.) | acid + succinic acid | | | |
| 3 | poly | 150 | 4 | 153 |
| (prior art) | (methylenediphenyl | | | |
| | isocyanate) resin | | | |
| 4 | phenol- | 150 | 4 | 158 |
| (prior art) | formaldehyde | | | |
| | urea resin | | | |

It can be seen that the use of sizing composition no. 1 comprising pre-polymerized lignin ester A obtained according to the method of the invention (that is, after dilution of binder composition no.1 obtained by preheating lignin A with succinic acid in the presence of acetic acid in an essentially anhydrous medium, in other words in a medium containing less than 5% by weight of water) makes it possible, for a given oven temperature equal to 150° C., to accelerate the duration required for the sizing composition to cure on the wood fibers to form the organic binder (because duration: 4 minutes), in other words to obtain an insulation product with an equivalent storage modulus (approximately 100 MPa) compared with the use of a binder composition comprising lignin A which has not undergone pre-polymerization, such as sizing composition no. 2 (duration: 10 minutes).

In addition, although the storage modulus obtained for wood fiber specimens prepared in accordance with the invention is slightly lower (of the order of 100 MPa) compared with wood fibers prepared using sizing compositions that are known but are harmful and too reactive, such as poly(methylenediphenyl isocyanate) or phenol-formaldehyde urea resins (the storage modulus of which is approximately 155 MPa), the mechanical properties of the wood fibers obtained according to the invention are good. A storage modulus of approximately 100 MPa for insulation products having a density of 180 kg/m³ is satisfactory.

### Example 2

Compositions no. 5 and 5 bis according to the prior art are prepared by successively introducing, into a container, 48 parts by weight of maltitol (as hydrogenated sugar), 52 parts by weight of citric acid, and 5 parts by weight of sodium hypophosphite (catalyst) under vigorous stirring until the constituents are completely dissolved.

Each sizing composition described above, 1, 2, 5 and 5bis, is then used to impregnate glass fibers. All sizing compositions 1, 2, 5 and 5 bis contain 90% by weight of water and 10% by weight of dry matter. All the compositions are used to form glass-fiber based insulating products.

Thus, two stacked pieces (60 mm×10 mm×0.250 mm) of non-woven glass fiber paper are impregnated respectively with each of the aqueous sizing compositions, then the impregnated glass fiber papers are cured at a temperature of 150° C. for 4 minutes (for samples 1, 2, 3 and 5) or 210° C. for 10 minutes (for sample 5bis).

The flexural storage modulus (three-point bending) is then determined for each specimen by dynamic mechanical thermal analysis (DMTA) using a “TA Instruments RSA-G2 Analyzer” device. The samples are first dried for several hours in a desiccator under dynamic vacuum (20 mbar). The operating parameters of the measuring device are the same as those mentioned above.

Table 2 below shows:
the temperature and duration required, during the step of heating the glass fibers until each of the sizing compositions cures, to form the organic binder and hence the insulation product, and
the storage modulus of glass fiber papers obtained after each of the sizing compositions is cured. Each storage modulus value is the calculated average of two to four individual measurement values.

### Results

TABLE 2

| | Binder composition | | | Conversion |
|---|---|---|---|---|
| | on glass fibres | | Duration | module |
| Sample | comprising | T°C | (min) | (GPa) |
| 1 | pre-polymerized | 150 | 4 | 1.65 |
| (inv.) | lignin ester A | | | |
| 2 | lignin A + acetic | 150 | 10 | 1.75 |
| (comp.) | acid + succinic acid | | | |
| 5 | resin based on | 150 | 4 | 0.26 |
| (prior art) | hydrogenated sugar | | | |
| 5bis | resin based on | 210 | 10 | 1.18 |
| (prior art) | hydrogenated sugar | | | |

It can be seen that the use of sizing composition no. 1 comprising pre-polymerized lignin ester A obtained according to the method of the invention (that is, after dilution of binder composition no.1 obtained by preheating lignin A with succinic acid in the presence of acetic acid in an essentially anhydrous medium, in other words in a medium containing less than 5% by weight of water) makes it possible, for a given oven temperature equal to 150° C., to accelerate the duration required for the sizing composition to cure on the glass fibers to form the organic binder (because duration: 4 minutes), in other words to obtain an insulation product with an equivalent storage modulus (1.65 GPa) compared with the use of a binder composition comprising lignin A which has not undergone pre-polymerization, such as sizing composition no. 2 (duration: 10 minutes).

It is also observed that the use of sizing composition no. 1 comprising pre-polymerized lignin ester A makes it possible to obtain glass fiber papers having good mechanical properties (storage modulus equal to 1.65 GPa), which properties are much better than those obtained for glass fiber papers prepared using known sizing compositions 5 and 5 bis based on hydrogenated sugar (storage modulus equal to 0.26 and 1.18 GPa).

In addition, the use of sizing composition no. 1 comprising pre-polymerized lignin ester A makes it possible to lower the temperature of the step of heating the glass fiber assembly and to accelerate the duration of the step of heating the glass fiber assembly to form the organic binder compared with the use of a binder composition based on hydrogenated sugar (compositions 5 and 5 bis).

1. A method for preparing a thermosetting binder composition, comprising:
mixing at least one lignin, at least one organic monocarboxylic or sulfonic acid, and at least one organic non-polymeric polycarboxylic acid to form a mixture, and
heating said mixture at a temperature of between 90° C. and 170° C. for a duration of between 5 seconds and 5 minutes so as to form at least one water-soluble or water-dispersible lignin ester.

2. The method according to claim 1, wherein the mixture of at least one lignin, at least one organic monocarboxylic or sulfonic acid, and at least one organic non-polymeric polycarboxylic acid, contains less than 5% water by weight.

3. The method according to claim 1, wherein the at least one lignin is selected from alkaline lignins, lignosulfonates, organosolv lignins, sodium lignins, lignins from the process for biorefining lignocellulosic raw materials, or a mixture thereof.

4. The method according to claim 1, wherein the at least one organic non-polymeric polycarboxylic acid is selected from at least one dicarboxylic acid, at least one tetracarboxylic acid; and at least one tetracarboxylic acid.

5. The method according to claim 1, wherein the at least one lignin represents at least 50% of the total weight of the at least one organic non-polymeric polycarboxylic acid and the at least one lignin.

6. The method according to claim 1, wherein the at least one organic monocarboxylic acid is selected from the group consisting of formic acid, acetic acid, propionic acid, butyric acid, isobutyric acid, pentanoic acid, isovalerianic acid, hexanoic acid, heptanoic acid, octanoic acid, nonanoic acid, decanoic acid, undecanoic acid, dodecanoic acid, tridecanoic acid, tetradecanoic acid, pentadecanoic acid, palmitic acid, heptadecanoic acid, stearic acid, nonadecanoic acid, arachidic acid, behenic acid, lignoceric acid, cerotic acid, myristoleic acid, palmitoleic acid, sapienic acid, oleic acid, elaidic acid, trans-vaccenic acid, linoleic acid, linolelaidic acid acid, α-linolenic acid, γ-linolenic acid, dihomo-γ-linolenic acid, arachidonic acid, eicosapentaenoic acid, clupanodonic acid, docosahexaenoic acid, crepenynic acid, tuberculostearic acid, phytanic acid, lactobacillic acid, malvalic acid, chaulmoogric acid, gorlic acid, 11-cyclohexylundecanoic acid, 13-phenyltridecanoic acid, furanic fatty acids, pentacycloanammoxic acid and benzoic acid.

7. A thermosetting binder composition that is obtainable by the method according to claim 1, said binder composition containing at least one water-soluble or water-dispersible lignin ester, at least one residual lignin, at least one free residual organic non-polymeric polycarboxylic acid, and at least one free residual organic monocarboxylic or sulfonic acid.

8. The thermosetting binder composition according to claim 7, wherein the thermosetting binder composition has a pH of between 2 and 6 at 10% by weight in aqueous solution.

9. The thermosetting binder composition according to claim 7, wherein the thermosetting binder composition has a water content of less than 3% by weight.

10. The thermosetting binder composition according to claim 7, wherein the content of free residual organic non-polymeric polycarboxylic acid is at most 45% by weight, relative to the total dry weight of the thermosetting binder composition, and the content of free residual organic monocarboxylic acid or the content of free residual organic sulfonic acid is at most 45% by weight, relative to the total dry weight of the thermosetting binder composition.

11. A method for manufacturing an insulation product comprising mineral fibers or natural organic fibers bonded by an organic binder, said method comprising:
(a) preparing a sizing composition by diluting a thermosetting binder composition according to claim 7 with water until a dry matter content of between 1% and 20% by weight is reached,
(b) applying the sizing composition to said mineral fibers or said natural organic fibers,
(c) forming an assembly of said sized mineral fibers or said sized natural organic fibers, and
(d) heating the assembly of said mineral fibers or said natural organic fibers until said sizing composition has cured to form the organic binder.

12. The method according to claim 11, wherein the mineral fibers are glass fibers or rock fibers or slag fibers, or mixtures thereof.

13. The method according to claim 11, wherein the natural organic fibers are selected from fibers of wood, hemp, flax, sisal, cotton, jute, coconut, raffia, abaca, or cereal straw or rice straw.

14. The method according to claim 11, wherein step (d) comprises heating said assembly of fibers at a temperature of between 90° C. and 170° C. for a duration of between 1 and 10 minutes.

15. An insulation product that is obtained by a method according to claim 10.

16. The method according to claim 1, wherein said mixture is heated at a temperature between 110° C. and 150° C. and/or the duration is between 15 seconds and 1 minute.

17. The method according to claim 1, wherein the mixture of at least one lignin, at least one organic monocarboxylic or sulfonic acid, and at least one organic non-polymeric polycarboxylic acid, contains less than 1% water by weight.

18. The method according to claim 2, wherein the mixture is anhydrous.

19. The method according to claim 4, wherein the at least one dicarboxylic acid is oxalic acid, malonic acid, succinic acid, glutaric acid, adipic acid, pimelic acid, suberic acid, azelaic acid, sebacic acid, malic acid, tartaric acid, tartronic acid, aspartic acid, glutamic acid, fumaric acid, itaconic acid, maleic acid, traumatic acid, camphoric acid, phthalic acid, optionally containing at least one boron or chlorine atom, tetrahydrophthalic acid, optionally containing at least one chlorine atom, isophthalic acid, terephthalic acid, mesaconic acid and citraconic acid, wherein the at least one tricarboxylic acid is citric acid, tricarballylic acid, 1,2,4-butanetricarboxylic acid, aconitic acid, hemimellitic acid, trimellitic acid and trimesic acid, and wherein the at least one tetracarboxylic acid is 1,2,3,4-butanetetracarboxylic acid and pyromellitic acid.

20. The method according to claim 5, wherein the at least one lignin represents at least 50% to 80% of the total weight of the at least one organic non-polymeric polycarboxylic acid and the at least one lignin.
